(19) United States
(12) Patent Application Publication
(10) Pub. No.: US 2023/0249567 A1
(43) Pub. Date: Aug. 10, 2023

(54) MODULAR SCALABLE FAST CHARGING SYSTEM

(71) Applicant: Gravity, Inc., New York, NY (US)

(72) Inventors: Moshe Cohen, New York, NY (US); Nader Lotfy, Pasadena, CA (US); Nikolai Syssoev, Agoura Hills, CA (US); Peter Delioussine, Newbury, CA (US)

(73) Assignee: Gravity, Inc., New York, NY (US)

(21) Appl. No.: 18/161,532

(22) Filed: Jan. 30, 2023

Related U.S. Application Data
(60) Provisional application No. 63/304,852, filed on Jan. 31, 2022.

(51) Int. Cl. B60L 53/31; B60L 53/302; B60L 53/62; B60L 53/65; B60L 53/63

(52) U.S. Cl. CPC B60L 53/31; B60L 53/302; B60L 53/62; B60L 53/65; B60L 53/63

(57) ABSTRACT

The present invention provides a scalable fast charging system for electric vehicles for large parking structures, curb-side charging, work-place charging, or MuD's charging. A centralized power processing unit processes power from AC to multiple HVDC outputs, with these multiple HVDC outputs available in small power increments that lend themselves to be easily paralleled and an optional energy storage system. A centralized switch matrix distributes and shares the power from the power processing outputs to any one, or any multiple, dispensers based on the power needs at the various dispenser. A centralized cooling system cools various cables and charging cables in the dispensers and is located away from the dispensers where more space is available. An array of small dispensers are installed at the point of use where the vehicles are to charge. Further, a switch matrix controller optimizes delivery of power to each of the dispensers to optimizer overall performance.

### CROSS REFERENCE TO RELATED APPLICATION

This patent document claims priority to earlier filed U.S. Provisional Patent Application Ser. No. 63/304,852, filed Jan. 31, 2022, the entire contents of which are incorporated herein by reference.

### BACKGROUND OF THE INVENTION

The present invention is made for the purpose of fast-charging electric vehicles. It relates to the automotive, energy and energy storage sectors.

The adoption of Electric Vehicles (EVs) continues to increase year after year, but several limiting factors still remain, one of which is the high cost and the complexity of building out of the necessary charging infrastructure to support EV users and help them charge in a fast and convenient way.

More specifically, currently, in large public parking structures, the common approach to accommodate fast EV DC charging, is to install a DC fast charger for each individual parking spot. This solutions is very costly, since there is an individual charger for each parking spot. This solution also uses a large part of each individual parking spot to accommodate the footprint to install the charging equipment.

This process has proven to be problematic, especially in existing parking structures with limited available space, and also where there is a limited available funds to deploy the solution.

Curb side charging also suffers from similar issues, since by its nature, the footprint available to install the charging equipment needs to be very small as not to impeded foot traffic.

Also, work-place charging suffers from many of these issues as well, with the added problem where employees driving EVs typically would like to park their EVs and leave them there for the entire work-day, even after the actual charging is finished, thus hogging these spots and denying other EV driving employees' access to the charging equipment. This problem often results in EV users resorting to scheduling schemes where they swap parking spots to ensure everyone gets access. This is not an efficient use of anyone's time.

Multi Unit Dwellings (MuDs) are also problematic. Currently, it's common for a specific parking spot to be associated with a specific condo or apartment. Therefore, an issue may arise as to who is responsible for the cost of installation and also what happens when the EV user decides to leave is no longer a resident of the condo or apartment. If the cost of an EV-compatible parking spot is very expensive, this may raise problems. Therefore, there is a need to greatly reduce the cost of a given EV-compatible parking spot.

In particular, in the case of high power, EV DC fast charging stations intended to charge potentially multiple cars at the same time, there is a need to optimize the solution to ensure minimum cost, maximum user convenience, and minimum space usage at the charging station site.

There is a need in the industry that can address the foregoing problems and shortcoming in the prior art, specifically as it applies to charging at large public parking structures, curb side charging, work-place charging, and charging in (MuDs).

It should also be noted that existing equipment is not particularly attractive in appearance, not user friendly, and not designed to fit in indoor, or space constrained parking. Second, existing fast charging equipment is large (and tall) and therefore can generally not fit in common parking garages. Equipment is designed to stand on the ground, thus requiring significant height of ceiling as well as additional width and depth to parking, which is often not available.

Moreover, traditional fast chargers are slow, most often rate of charge limited by vehicle, and large, making them impossible to use in indoor garages and smaller spaces. They are also loud with liquid to air fans, and very expensive to install and upgrade. Therefore, there is a need for charging systems that are quieter, particularly at locations where equipment is proximal to the end user, such as near an actual vehicle being charged.

There is also a need for the charging speeds for commercial and residential charging to be increased to reduce the charging time for the end user. Therefore, charging speeds need to be minutes or hours, particularly where there is limited physical space for the equipment and power supply. This can be particularly challenging because the vehicles are as much of a limiting factor as “fast” charging.

Existing equipment does not address these issues and is primarily installed outdoors.

Furthermore, existing equipment is generally an “all-in-one” where the system components are housed in one large enclosure. This generally requires the removal and replacement of the equipment in the presence of meaningful upgrades. There are no known high quality and viable systems that are fully modular, where upgrades can be made periodically, and new technologies can be incorporated by swapping out or upgrading specific components rather than having the swap the whole unit or system. In that connection, there is a need for the site to be able to add or upgrade charging stations or add or upgrade power, where the two components (i.e., stations and power) should be independent. However, utilization will still be limited by the total available power including local energy storage). True modularity helps with costs and maintaining the optimal system over the course of years.

### SUMMARY OF THE INVENTION

The objective of the present invention is to make fast charging available everywhere there is parking. Fast charging must become more accessible and prevalent. Space constraints preclude the use of existing equipment and inhibit EV adoption.

The present invention provides a solution to the space constraint problem and the current lack of modularity and scalability. The cost of the system of the present invention, including maintenance and upgrades, is much lower than prior art systems as all the parts can be upgraded separately and sites can be flexibly expanded.

The above issues all point to problems with the current way we approach charging infrastructure in large parking structures, curb-side charging, work-place charging, or MuD's charging.

The present invention provides the following new and novel features to address the shortcomings and problems with the prior art systems. The features of the present invention include the following:

A central power cabinet containing multiple AC-DC converters, which convert AC power to HVDC. These converters can be paralleled internally to output to individual dispensers.

An optional energy storage system that allows for some energy to be available to augment operation at high peak power demand to ensure lowest possible cost of AC power and minimum demand on the grid.

An optional power meter to monitor the power consumptions of electric loads in an associated building to allow the charging system to adjust its maximum allowable power such that the total power consumption of the building as well as the charging infrastructure remains below a predefined limit based on available power.

A centralized switch matrix contained within the power cabinet allows for any available AC-DC converter to be paralleled and routed to any individual dispensers.

A centralized cooling system to cool the charging cables connecting the vehicles and the dispensers, to be installed away from the dispensers, where space utilization is not at a premium.

An array of small dispensers installed at the point of use where the vehicles are to charge.

A switch matrix controller capable of negotiating vehicle charging needs, as well as the available power (and on-site battery storage), as well as energy and thermal limits and constraints, and decides on the optimal distribution of power outputs to the various dispensers to optimize operation.

The present invention is an advance over the prior art and is critical to EV fleet owners and will be critical to other fleet owners, municipalities, developers, and the like, who want future proof solutions that can fit in the footprint of existing parking spaces and that can accommodate the future innovations in the components, expected over the next few years.

The system of the present invention uniquely provides superior commercial and residential charging where charging speeds need to be minutes or hours and all within a limited physical space and power supply.

A user interface that allows the user to input various parameters, including but not limited to, desired amount of energy to be gained during this charging session, as well as expected available time for the charge session.

### BRIEF DESCRIPTION OF THE DRAWING FIGURES

Further advantages, features and possible applications of the present invention are shown and described in the accompanying drawing figures.

FIG. 1 is a front perspective view of an electric vehicle in the process of charging at the modular scalable fast charging system of the present invention;

FIG. 2 shows as schematic view of the coolant system with coolant chiller circuit loop of the scalable fast charging system of the present invention;

FIG. 3 is a schematic top level view of the coolant system routing and tube diagram used in the system of the present invention;

FIG. 4 shows the details of the chiller construction and internal components thereof;

FIG. 5 is a schematic view of the coolant distribution skid with details of the construction and internal components thereof;

FIG. 6 is a schematic view of the dispenser charging station cooling system with details of the construction and internal components thereof;

FIG. 7 is a schematic view of the switch matrix circuit used in the present invention;

FIGS. 8A and 8B show schematic views of two embodiments of the precharge circuit options in accordance with the present invention;

FIG. 9 is a representational image of the centralized power system of the present invention located in a power cabinet located remotely compared to the localized dispensers disposed in each charging station;

FIG. 10 shows a table illustrating the technical specifications for the centralized power system of the present invention;

FIG. 11 is a table illustrating the technical specifications for the localized dispenser of the present invention;

FIG. 12 shows an electrical EV charger power one-line diagram showing the present invention installed at a first example location;

FIG. 13 shows a front perspective view of two vehicles simultaneously being charged using two wall-mounted dispensers of the present installed next to one another in adjacent parking spots where the power system is located at a remote location therefrom;

FIG. 14 shows a top view of FIG. 9;

FIG. 15 shows a front elevational view of FIG. 9;

FIG. 16 shows a side elevational view of FIG. 9;

FIG. 17 shows a ceiling mounted embodiment of the dispenser of the present invention;

FIG. 18 shows a free-standing mounted embodiment of the dispenser of the present invention;

FIG. 19 shows a wall-mounted embodiment of the dispenser of the present invention;

FIG. 20 shows another embodiment of the dispenser of the present invention;

FIG. 21 is a front view of the embodiment of the dispenser of FIG. 16;

FIG. 22 is a bottom view of the embodiment of FIG. 16;

FIG. 23 is a side view of the embodiment of FIG. 16;

FIG. 24 is a bottom perspective view of another embodiment of the dispenser of the present invention;

FIG. 25 is a top perspective view of the embodiment of FIG. 20;

FIG. 26 is a front perspective of the electronic control box for the dispenser in accordance with the present invention;

FIG. 27 is a side view of the control box of FIG. 22;

FIG. 28 is a front view of the control box of FIG. 22;

FIG. 29 is a top view of the control box of FIG. 22;

FIG. 30 is an exploded perspective of the control box of FIG. 22;

FIGS. 31-36 shows status control lights for the dispenser and power cabinet of the system of the present invention;

FIGS. 37, 39, 40, 41, 43, and 44 show a visual representation of the status of the vehicles being charged at various local dispenser locations by the system of the present invention; and

FIGS. 38, 42, 44, and 45 show details for a specific vehicle being charged a given charging station using the dispenser of the present invention.

### DESCRIPTION OF THE INVENTION

As further shown in the attached figures, the system 10 of the present invention provides a hub with the power equipment in a power cabinet in a remote location and a number the “dispensers” 12 located within the parking facility that are connected to it. This avoids having to provide voluminous power equipment at each parking spot.

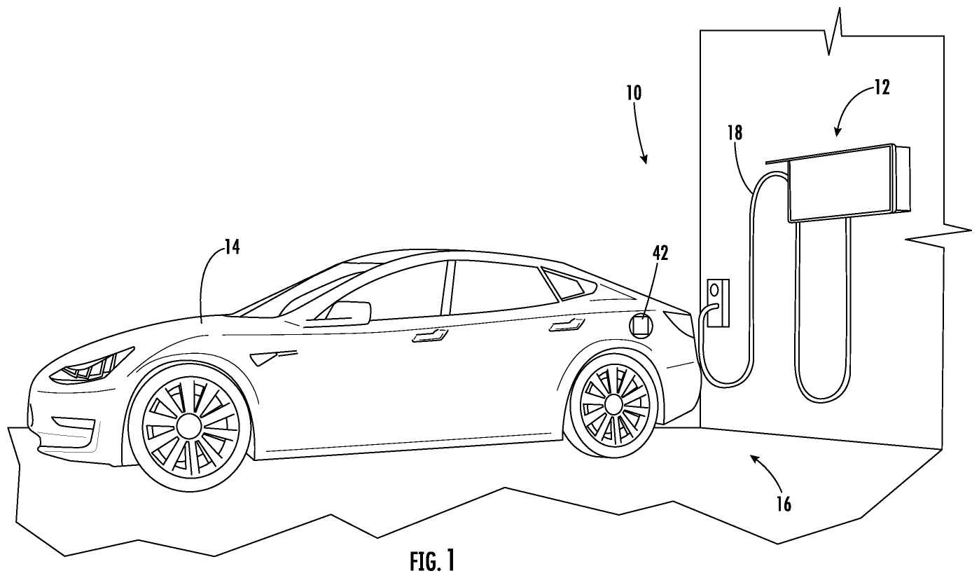

Turning first to FIG. 1, an electric vehicle 14 is shown in the process of being charged using a dispenser 12 of the present invention is receives power from a remotely located power equipment to save space locally in and around the area of the vehicle 14 being charged.

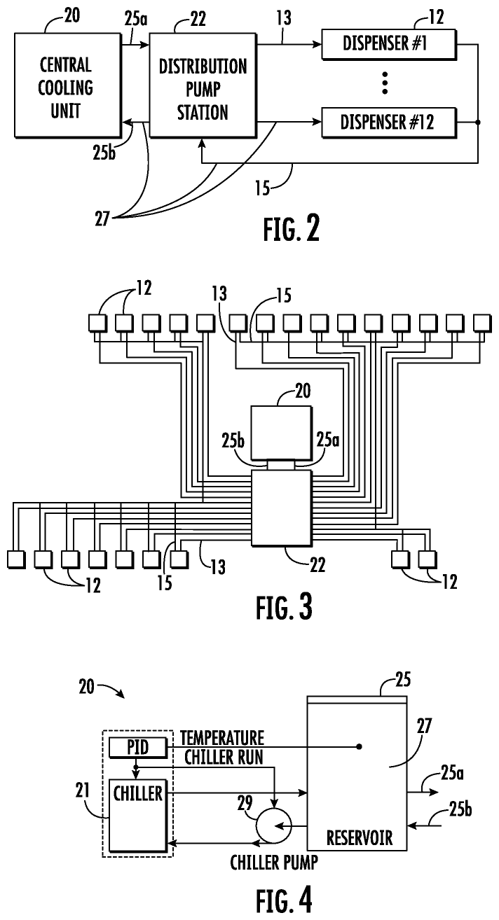

In FIG. 2, shows a centralized chiller and pump station located remotely compared to the dispensers 12 located at each of the charging stations 16 to ensure that power charging cables 18 are kept cool and therefor safe at all times. Coolant supply lines 13 and coolant return lines 15 are shown to illustrate the coolant circuit of the present invention. Further, FIG. 3 shows a coolant system tube diagram where the coolant skid and multiple dispensers are connected thereto with coolant supply and return lines shown.

FIG. 4 shows further details of the construction and components of the centralized cooling unit 20. It includes a chiller 21 that cools the primary side coolant 27 for the dispensers 12. The chiller 21, a proportional integral derivate (PID) controller 23, and reservoir 25 are shown. They may simply be replaced with a simple liquid-to-air heat exchanger in some cases where the primary coolant does not have to be cooled below the ambient air temperature.

The primary coolant is stored in an internal reservoir 25 of the chiller unit 20, at a set temperature. The reservoir 25 has outlet port 25a and inlet port 25b; the outlet 25a supplies coolant 27 to the coolant distribution system, whereas the inlet 25b is for the return of used coolant 27. The coolant distribution system 22 pumps fresh coolant 27, using pumps 33, to the dispensers 12 when they are in use. Furthermore the coolant distribution system is also responsible for maintaining fresh coolant 27 within the plumbing between distribution system 22 and dispensers 12. This is accomplished by a scheduled circulation cycle, where an unused dispenser 12 will have its coolant 27 circulated.

This arrangement has several advantages; the scheme eliminates the need for a large circulation pump 29 that must continuously circulate coolant 27 at pressure even when no dispensers 12 are in use, furthermore it isolates the two coolant loops. Separating the coolant loops has the advantage of being able to use inexpensive coolant 27 in the primary loop, whereas in areas where coolant will potentially come into contact with HVDC a much smaller volume, of albeit more expensive coolant 24, is used.

Referring now to FIG. 5, a schematic view of the coolant distribution skid 22 with details of the construction and internal components thereof. A coolant distribution skid 22 or optionally a plurality of skids 22 are provided each with a coolant manifold 31, and dispenser pumps 33 that are respectively interconnected to the dispensers 12 preferably, via check valves 35. Preferably, flow and temperature transducers 37 for each dispenser supply leg are provided. Thus, a coolant supply 13 and return loop 15 is provided for provided coolant 27 to each dispenser location 12.

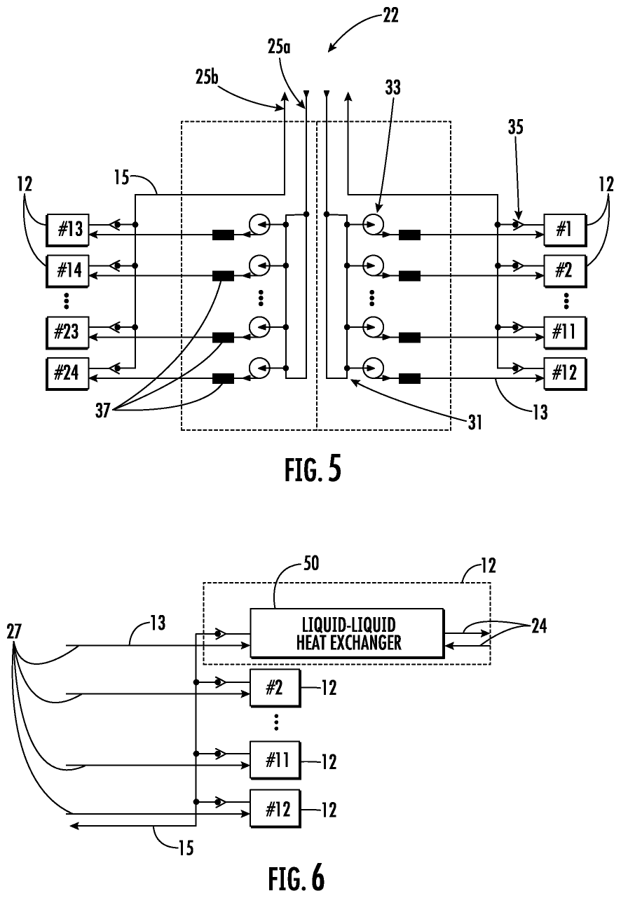

FIG. 6 shows the cooling system within a charging station dispenser 12 with internal construction details shown. The dispenser 12 contains a liquid to liquid heat exchanger 50, which facilitates heat transfer between primary coolant 27 and high-dielectric secondary coolant 24. Detail is provided for a first dispenser 12 at the top of FIG. 6 but it should be understood that the other dispensers 12 preferably have the same configuration as the first dispenser 12.

FIG. 7 shows the switch matrix 32 with interconnections of the present invention. For example, each AC/DC converter 30 is interconnected to the switch matrix 32 so each dispenser/station 12 can be selectively used. The appropriate charge station 12 and external DC busses are provided as generally referenced at 39.

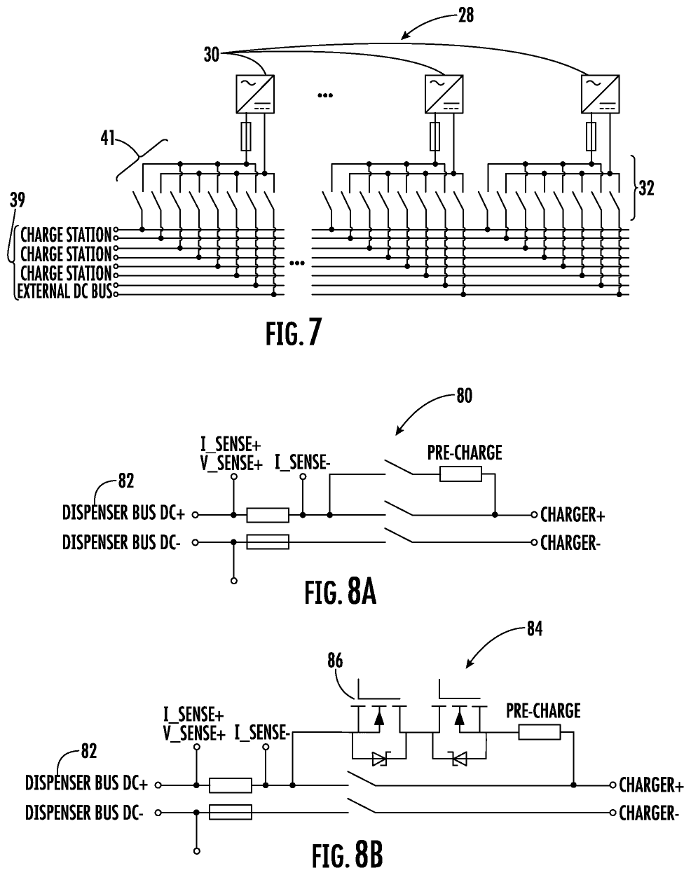

FIG. 8A shows a first embodiment 80 of a precharge circuit in accordance with the present invention 10. An appropriate dispenser bus DC 80 is provided, as shown. FIG. 8B shows a second embodiment 84 of a precharge circuit where bidirectional semiconductor metal-oxide-semiconductor field-effect transistor (MOSFET) switches 86 are used for improved operation.

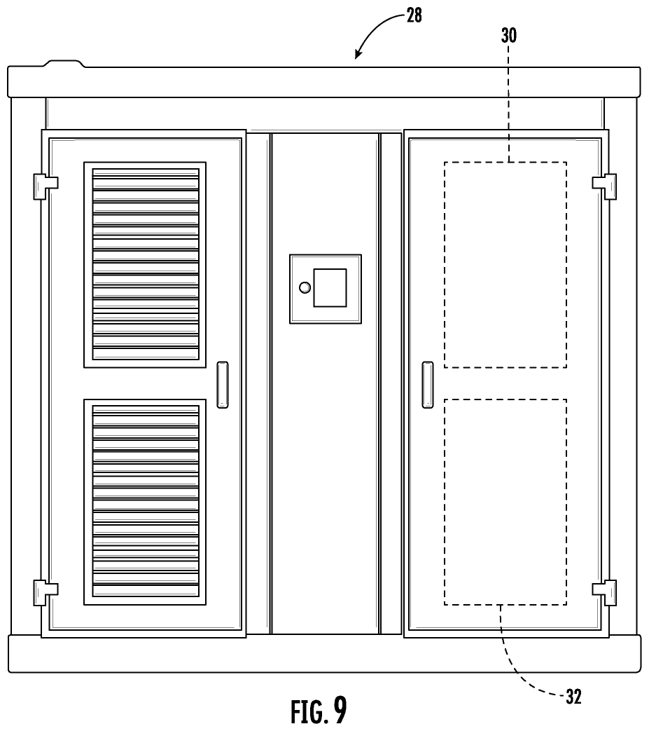

As in FIG. 9, the system of the present invention includes a power cabinet 28 that consists of an array of AC to DC converters 30, with multiple outputs that are galvanically isolated from each other, thus allowing these outputs to be used individually or to be electrically paralleled for a higher power charging. The electronics inside the power cabinet 28 are representationally shown as 30 in FIG. 9.

The switch matrix, shown in FIG. 7, is also representationally shown as 32 in FIG. 9, accepts all the individual power contributions from the AC-DC converters 30, and the on-site battery storage and through a matrix of electromechanical switches, allows the system 10 to distribute and redirect all the individual power outputs to the various dispensers 12 to optimize operation.

The unique and novel switch matrix 32 routes HV DC power from groups of multiple galvanically isolated AC-DC converters 30 to multiple individual dispensers 12, each charging an individual EV 14. The proposed switch matrix 32 of the present invention 10 uses a combination of electromechanical relays as well as bidirectional semiconductor metal-oxide-semiconductor field-effect transistor (MOSFET) switches 86 to ensure reliable and robust operation of the electromechanical relays by ensuring zero voltage switching across the mechanical contacts to minimize inrush currents and arcing which reduces the life of electromechanical relays.

The proposed sequence of operation would always require the various isolated AC-DC converter outputs to be regulated to the same voltage, then the bidirectional semiconductor MOSFET switch 86 to close first, thus ensure zero voltage operation for the electromechanical relays.

For the opening of the electromechanical relays, the reverse is proposed, where the mechanical relays open first, then the semiconductor MOSFET switches 86 open last, again ensuring zero voltage switching for the relays.

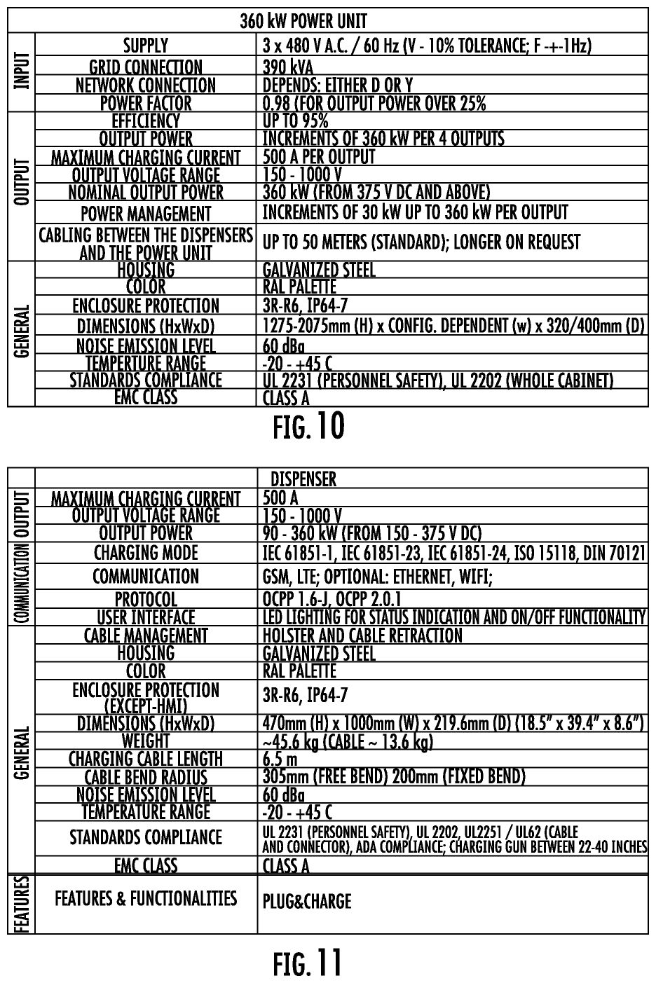

Thus, the present invention 10 uses a liquid to liquid cooling system, as described and shown in the operation specifications shown in FIG. 10 for the 360 kW power unit and, in FIG. 11 for a dispenser of the present invention. This feature cools the charging cables 18 locally (inside the dispenser 12 using a small tank and liquid circulation through the cables), in a compact form factor. A central chiller 20, as shown in FIG. 2, ensures a steady supply of coolant at a fixed temperature. Coolant distribution system 22 utilizes coolant stored in reservoir 25 to refresh all dispensers 12, with redundant systems so that any isolated fault does not take the system offline.

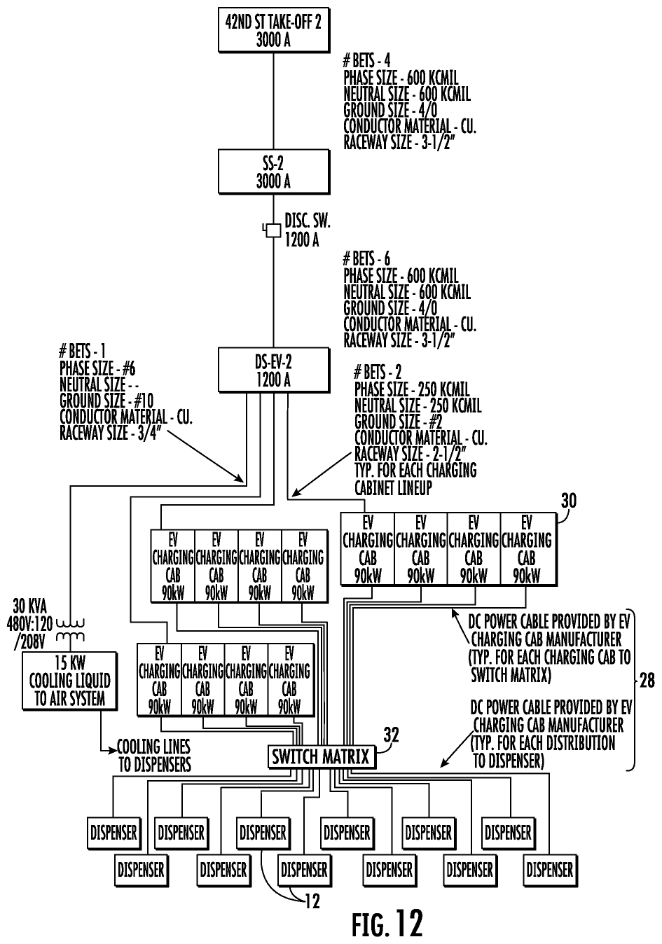

FIG. 12 shows an electrical EV charger power one-line diagram showing the present invention installed at a first example location. The installation of the present invention at other locations, such as a second location, would have the same or substantially similar diagram seen in FIG. 12.

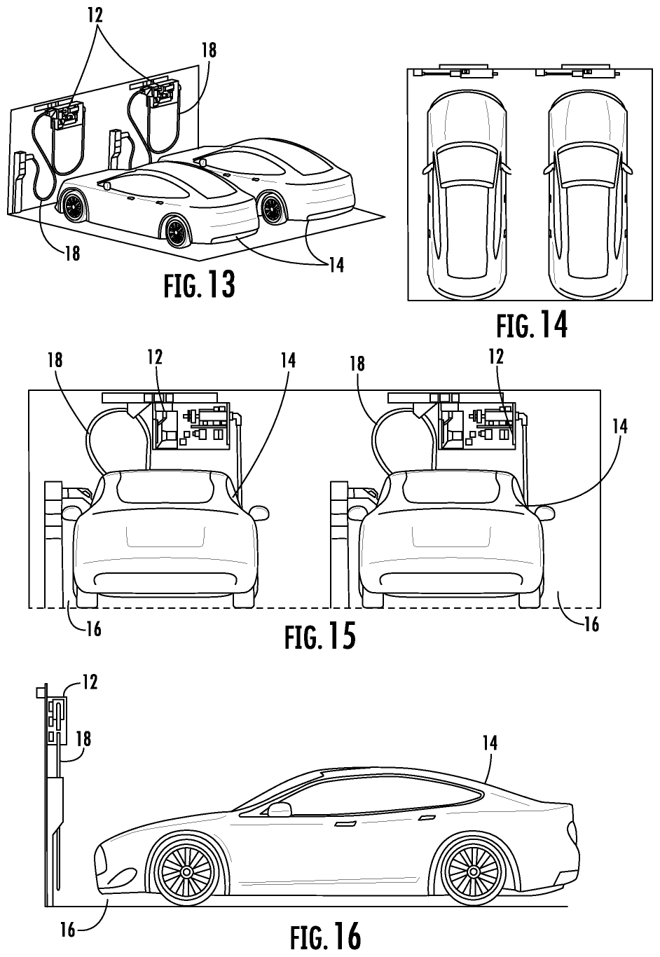

FIG. 13 shows a front perspective view of two vehicles 14 simultaneously being charged using two wall-mounted dispensers 12 of the present installed next to one another in adjacent parking charging stations 16 where the power system 28 is located at a remote location therefrom. FIG. 14 shows a top view of FIG. 13, while FIG. 15 shows a front elevational view of FIG. 13 and FIG. 16 shows a side elevational view of FIG. 13. This shows the flexibility and modular features of the present invention 10 where multiple vehicles 14 can charge near each because of the compact configuration of the dispenser 12 locally positioned at the vehicle 14 to be charged.

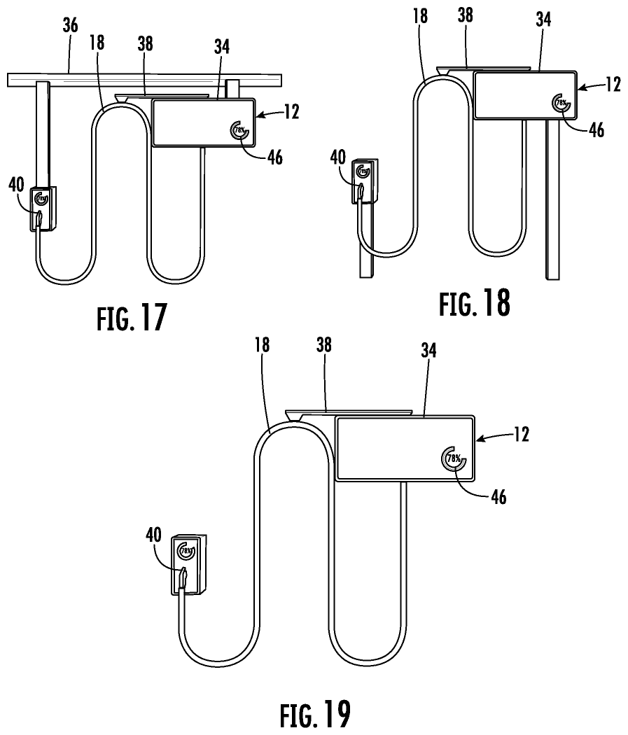

In FIG. 17 a ceiling mounted dispenser 12 is provided while FIG. 18 provides a post-mounted dispenser 12 where the dispenser packaging is be minimized. Still further, FIG. 19 shows a wall-mounted dispenser 12 in accordance with the present invention. As part of the dispenser 12, control box 34 is affixed to the appropriate bracket 36 or mount depending on the environment and particular installation at hand. An hanger armature 38 is provided to hold the liquid cooled charge cable 18. A first end of the charge cable 18 is connected to the electronics of the dispenser 12 and a second end, which is free, has the typical EV connector 40 for interconnection the appropriate charge port 42 on the vehicle 14.

Due to the centralized single power equipment 28, the individual dispensers 12 are compact because they do not include the power equipment locally at each parking spot 16, as shown referring back to FIG. 13-16.

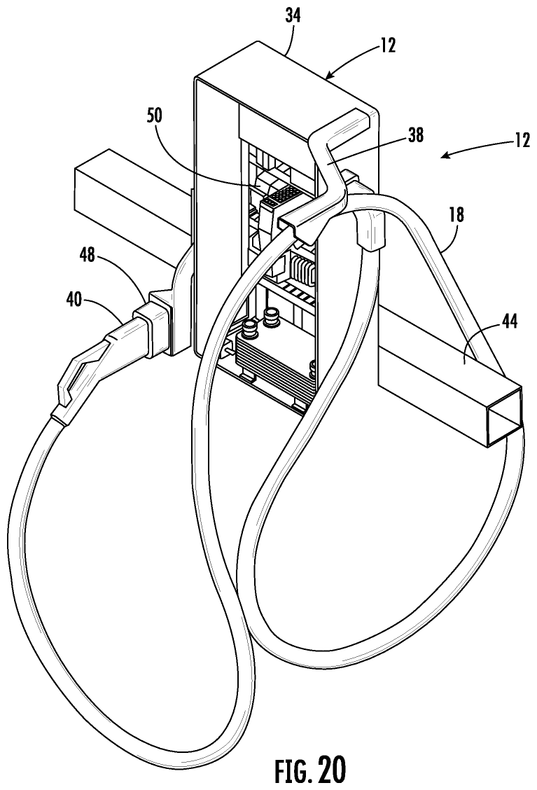

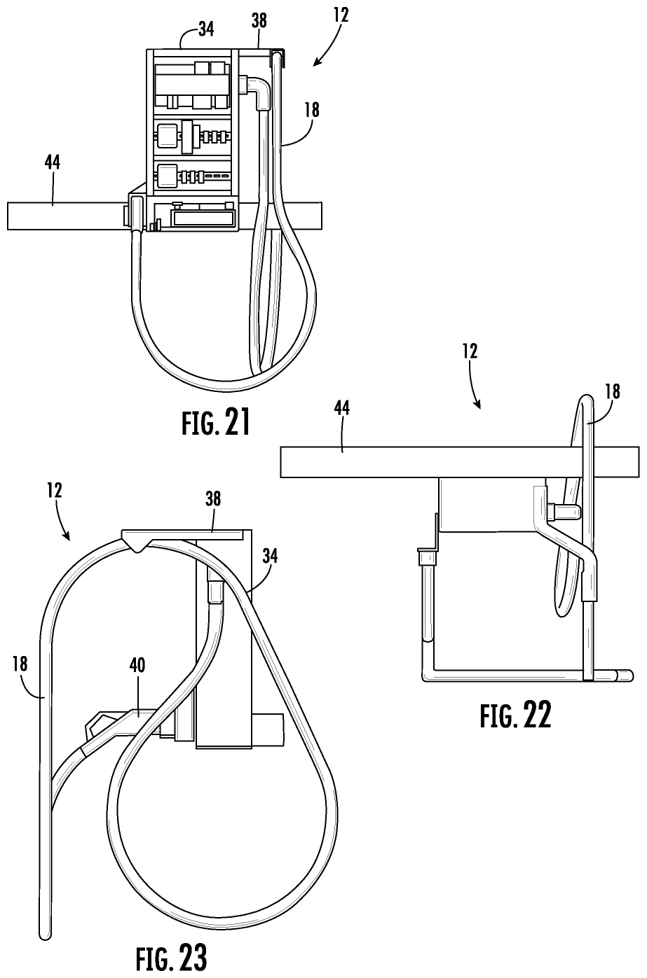

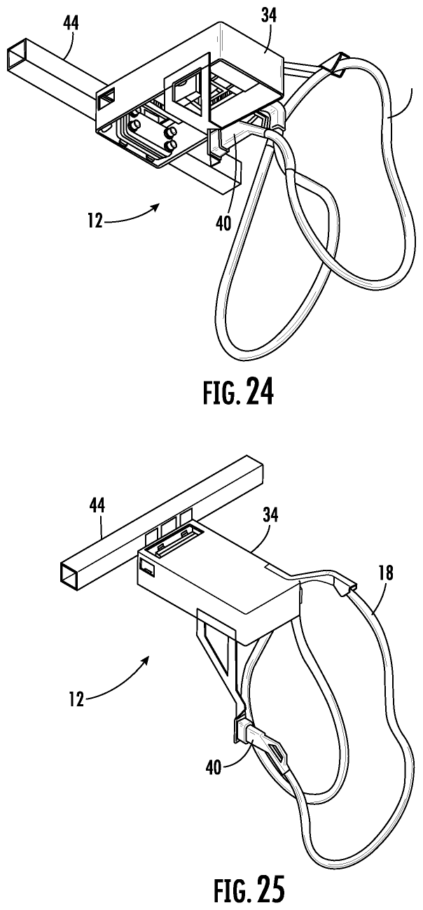

Referring now to FIG. 20, further details of the dispenser 12 of the present invention 10 is shown in detail. The electronics control 34 box is mounted to a bracket 44, which is shown configured to mount to a wall but other configurations may be used, as seen in FIGS. 17-19 with the front door removed for illustration purposes. The appropriate electronics, small liquid-to-liquid heat exchanger, local power supply, and the like are provided therein. The charge cable 18 is electronically interconnected to the electronics in the box 34 with the free end connector of the charge cable 18 being temporarily stored until charging is needed. FIG. 21 shows a front view while FIG. 22 shows a bottom view while FIG. 23 shows a side elevational view. As can be seen, the entire dispenser 12 size is very small, which is only possible because the power unit 28 is local in a remote but centralized location. FIG. 24 shows a bottom perspective view of another embodiment of the dispenser 12 of the present invention while FIG. 25 shows a bottom perspective view thereof where the dispenser box 34 is mounted to a support and where the charge cable 18 is connected to the box 34.

The control box 34, such as in FIG. 21, houses an electric brushless DC pump, a controller, heat exchanger, connector and power outlet cable 18. Also provided within control box 34 is a power outlet cable, the overall box assembly, surge arrester and din rail terminal blocks with Levers subassembly. Also, a power supply with a bracket is provided. Further, a bracket, holder, and cable are provided with a four inch main conduit.

Therefore, a significant advantage to charging system 10 of the present invention is its modularity. Unlike most EV charging stations, the charging system 10 of the present invention separates power equipment 28 and dispenser 12 in a hub like manner. System partitioning is also possible, which allows for updates and upgrades to be easily retrofitted. Since the power system is located in a power cabinet 28, parking space usage is efficient, and the system 10 can be easily scaled.

The solution is preferably provided in 360 kW increments allowing for the system 10 to be optimized for any location. The 360 kW cabinets consist of 12 30 kW sections. The switch matrix 32 allows for power distribution to be maximized by distributing power from the 30 kW sections wherever needed. The switch matrix 32 allows for power distribution to be maximized by distributing power from any number of 30 kw sections to any number of dispensers 12 as needed. If a 720 kW system is set up for 8 parking spots and only 2 of the charging locations 16 are being used, those two locations 16 combined can still utilize the entire 720 kw. The specifications for the power unit 28 is shown above in connection with FIG. 10.

Power distributed from the switch matrix 32, is routed through the custom dispenser 12 of the present invention. The dispenser 12 of the present invention includes an extremely small size of 0.1 cubic meters (3.6 ft\hat{ }3), compared to known prior art sizes ranging closer to 0.5 cubic meters (18 ft\hat{ }3). In addition to saving space, the system 10 can be wall mounted, floor mounted, or ceiling mounted. The combination of minimal size and instillation options makes it optimal for installation at any parking facility.

Moreover, each dispenser 12 is equipped with an LED based User Interface (UI) 46, as seen in FIGS. 17-19, that designates charging status. The dispenser 12 has Plug&Charge functionality making the consumer experience to charge very simple and intuitive.

Referring to FIG. 20, above, the dispenser 12 utilizes an independent holster 48 and a unique cable management system that allows the full use of the 6.5 meter length of cable 18. The holster 48 includes an interactive UI for enabling or disabling charging. A CCS type 1, liquid-cooled cable is used, supporting continuous 500 A over a voltage range of 150-1000 V. The full dispenser specifications are listed in the Table of FIG. 11.

To minimize size, an internal compact liquid-to-liquid heat exchanger 50 is used rather than a larger liquid to-air heat exchanger. The primary fluid 27 for the dispensers 12 extracts heat from the secondary fluid 24, and is then returned to a centralized chiller 20 where all other dispenser cooling is managed. As discussed previously, the chiller 20 is located close to the centralized power unit 28 but remote compared to dispensers 12 at the charging stations 16 and charging cable 18 to optimally saving parking space at a parking facility.

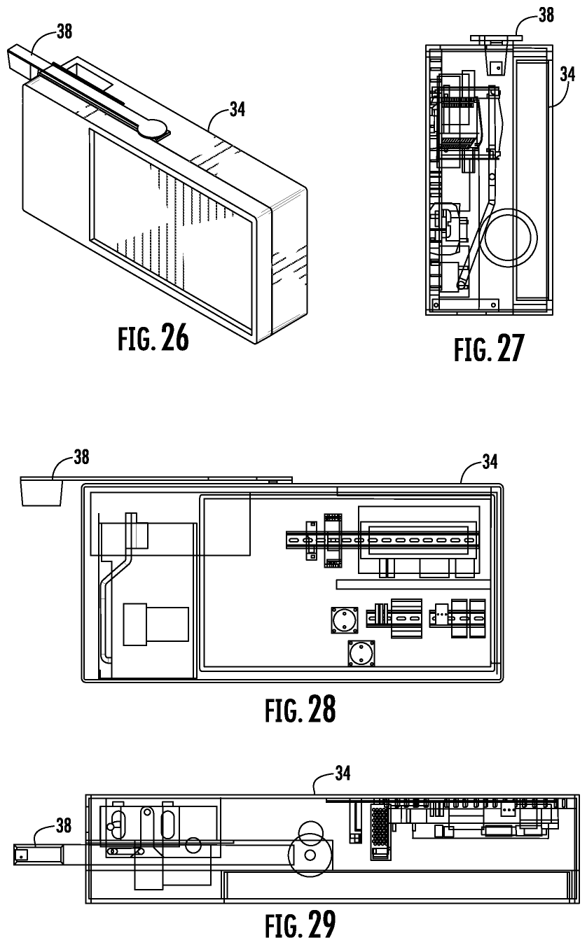

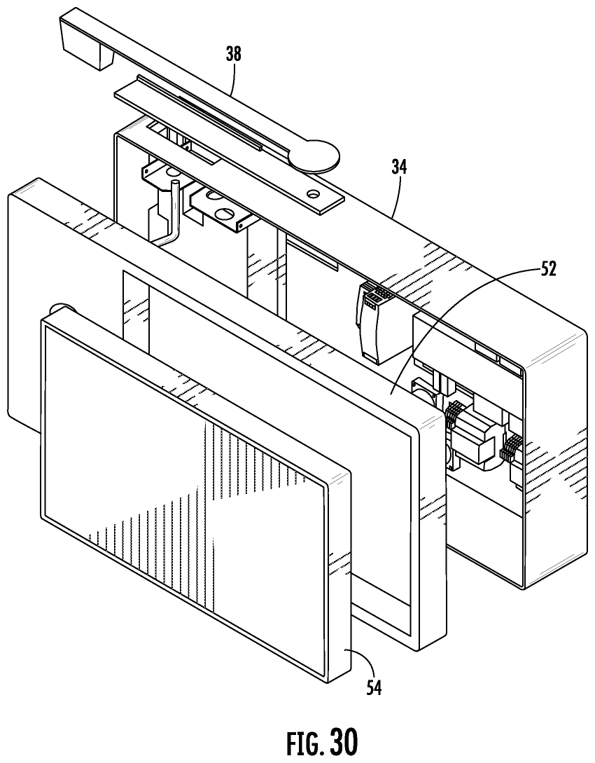

In FIGS. 26-29 details of the dispenser control box 34 is shown in detail. FIG. 26 is a front perspective of the electronic control box 34 for the dispenser 12 in accordance with the present invention. FIG. 27 shows a side view of the control box 34 of FIG. 26, FIG. 28 shows a front view of the control box 34, FIG. 29 shows a top view of the control box 34 of FIG. 30 and FIG. 29 shows an exploded perspective of the control box 34 of FIG. 30 with a front cover 52 and display panel 54. The appropriate dispenser electronics, as mentioned herein, are housed in the box 34 and the charge cable hanger 38 can be see connected to, preferably, the top portion of the dispenser box 34.

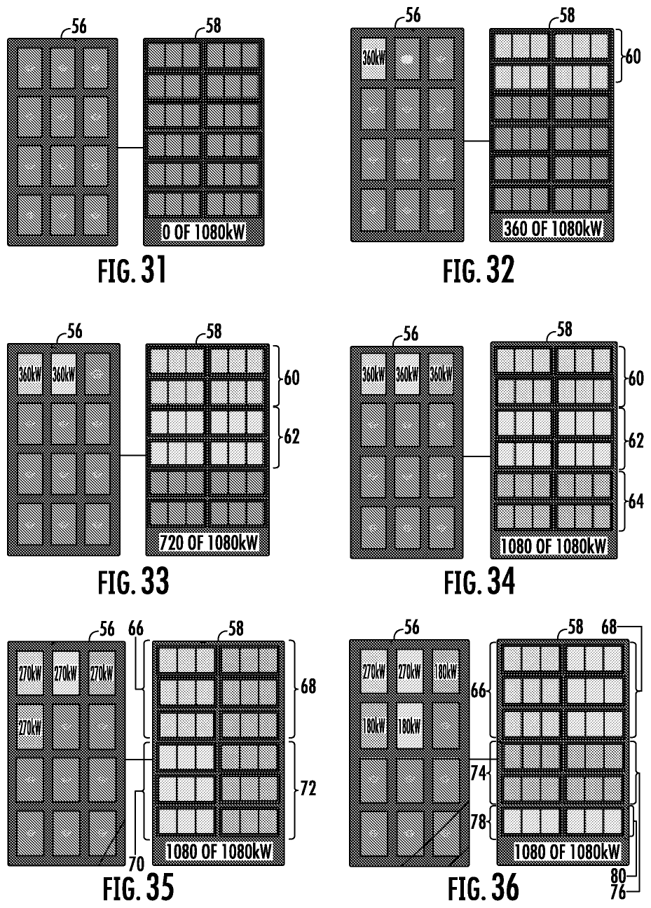

Further, FIG. 31-36 of the present invention show a switch matrix 32 and the different variations of use. Since the power is in 30 kW modules, power can be routed at 30 kW increments to any dispenser 12. For example, if there is 360 kW available, different variations of the division of power delivered. For example, it is possible to send all 360 kW to one dispenser 12, 330 kW to one dispenser 12 and 30 kW to another dispenser 12, 180 kW to two dispensers 12, and so on.

For example, in FIG. 31, no vehicles 14 are being charged and none of the 1080 kW measurement of power are being used, hence no lights are illuminated on panel 56. In FIG. 32, 360 kW is being used by a single dispenser 12 to charge a first vehicle 14 where the top two rows 60 of the display 58 are illuminated. In FIG. 33, two vehicles 14 are being charged at the same time. It can be seen in the dispensers screen 56, each dispenser is at 360 kW, the first two rows 60 are being charged and third and fourth rows 62 show the power cabinet display 56 indicates that the two vehicles 14 are being charged thereby using 720 kW being used. In FIG. 34, three dispensers 12 are now using 360 kW each wherein the power cabinet screen shows all of the tiles illuminated at 60, 62, and 64 and delivering a maximum of 1080 kW where the top two rows 60 correspond to use of a first dispenser 12 for charging a first vehicle 14, the middle two rows 62 for charging a second vehicle 14 and lowermost two rows 64 for charging a third vehicle 14 using a third dispenser 12. In FIG. 35, four dispensers 12 are now using 270 kW each on the power cabinet display indicate color and use by the dispensers 12. The upper left 3×3 array 66 of lights show one color corresponding to a first charging station 16 as indicated in the upper left, a 3×3 array for the upper right 68, a 3×3 array 70 for the lower left and a 3×3 array 72 for the lower right. FIG. 36 shows the use of five dispensers 12 where some of the dispensers 12 use 270 kW, where the dispensers 12, for example, use 270 kW, 270 kW, 180 kW, 180 kW, and 180 kW corresponding to the upper left 3×3 array 66 for a first dispenser 12, an upper right 3×3 array 68 for a second dispenser 12, a 3×2 array 74 for a third dispenser 12 and a 3×2 array 76 for fourth dispenser 12 shown and described herein and a 1×3 array 78 on the lower right and a 1×3 array 80 for the fifth dispenser 12.

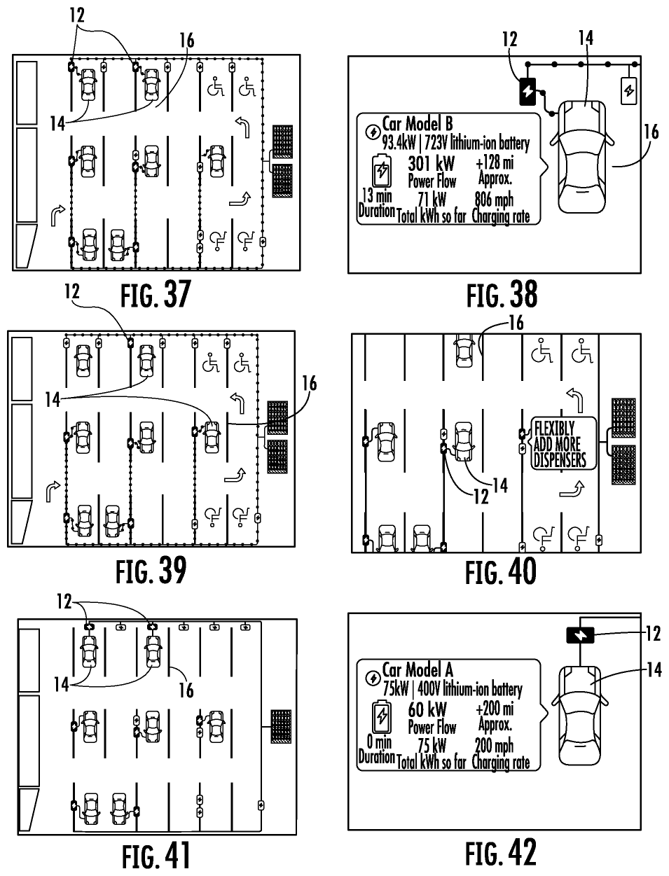

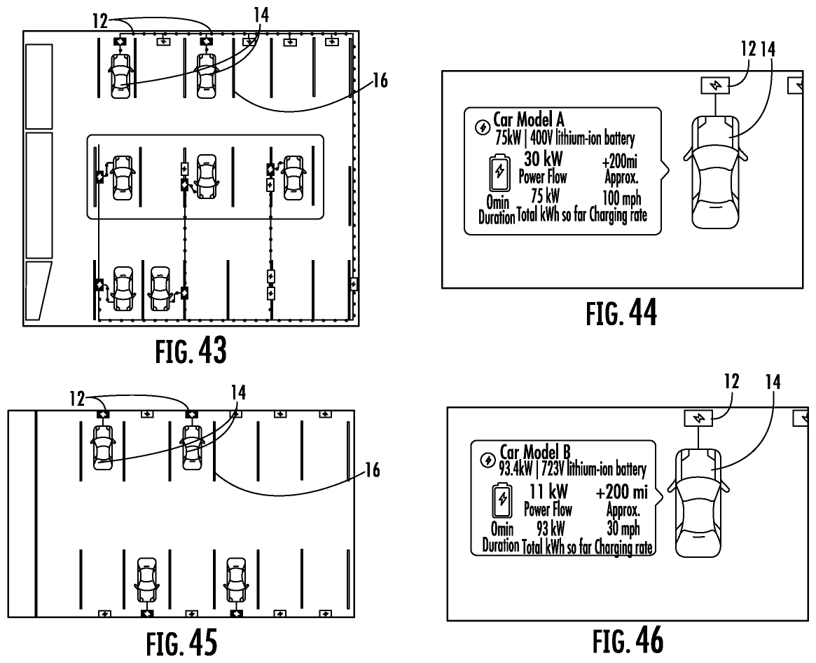

FIGS. 37-45 show specific case examples with different numbers of vehicles 14 simultaneously charging on the same system 10 of the present invention where they are charging in different locations 16 to illustrate the use of the present invention. This illustrates the flexibility of the present invention to accommodate any combination of vehicles 14 using the local dispenser 12 and centrally located power system 28, located in a power cabinet.

Optionally, an energy storage unit (not shown), allows the system 10 to extract and store energy from the utility grid when the grid energy demands it, and hence the pricing, is low, then supply that energy to the vehicles 14 charging when energy demand is high. This option enables the system operator to lower overall costs and is typically referred to as peak shaving. For example, an on-site battery storage may be employed to augment the total available capacity for the charging system. Batteries are charged from the grid when there is spare capacity not being used by the chargers and are then made available when additional capacity is required from vehicles on site. During times of high demand charges, batteries are charged at lower rates (for example up to the demand charge cutoff), and are then able be utilized for fast charging that does not incur demand charges.

Therefore, in accordance with the system of the present invention, several dispensers are provided, each one respectively individually charging a vehicle. Each dispenser has a liquid cooled charge cable, and a small liquid-to-liquid heat exchanger, as well as a controller that monitors the charge cable temperatures to ensure proper thermal operation.

The aforesaid examples are only one of the optimal modes of execution of the present invention and common changes and substitutes made by technical personnel of this field within the technical proposal of this invention should be included in the protection scope thereof. It would be appreciated by those skilled in the art that various changes and modifications can be made to the illustrated embodiments without departing from the spirit of the present invention. All such modifications and changes are intended to be covered by the appended claims.

What is claimed is:

1. A modular scalable fast charging system with a cooling system for electric vehicle charging stations, comprising:
a centralized chiller configured and arranged for maintaining a temperature of primary coolant;
a coolant reservoir fluidly connected to the centralized chiller to serve as a thermal buffer for the primary coolant;
a plurality of charging stations with dispensers connected thereto configured and arranged for charging individual electric vehicles;
liquid to liquid heat exchangers located within each charging station configured and arranged to decouple a primary coolant loop and a secondary coolant loop;
a dielectric heat transfer medium within the secondary coolant loop;
coolant distribution equipment comprising of distribution pumps, controls and a power supply;
wherein the distribution pumps supply primary coolant from the coolant reservoir to the charging stations as needed based on charging parameters;
a return pipe for collecting used primary coolant from the charging stations and recycling coolant back into the coolant reservoir.

2. The modular scalable fast charging system of claim 1, further comprising:
a centralized power system of the present invention remotely located from the localized dispensers disposed in each charging station.

3. The modular scalable fast charging system of claim 1, wherein the dispenser is wall-mounted.

4. The modular scalable fast charging system of claim 1, wherein the dispenser is ceiling-mounted.

5. The modular scalable fast charging system of claim 1, wherein the dispenser is mounted free-standing.

6. A switch matrix for a modular scalable fast charging system to route HV DC power from multiple galvanically isolated inputs to multiple individual dispensers, each charging an individual EV, comprising:
an array of galvanically isolated power converters configured and arranged for meeting vehicle battery voltage requirements;
an array of internally connected DC busses connected to individual power converters;
an array of externally connected DC busses connected to individual charging stations;
an array of high voltage contactors capable of flexibly making connections between the internally connected and externally connected DC busses wherein the multiple converters configured and arranged to be paralleled and external power sources configured and arranged to be redirected to a charging station thereby allowing for higher charging power without the need for high power converters dedicated to individual charging stations; wherein charging by an electrical grid need not be exclusively relied up with energy being sourced locally from either batteries or PV cells;
wherein the charging stations that are individually connected to the charging cabinet are contained an internal HVDC bus;
wherein the charging stations HVDC bus includes a pre-charge circuit, which provides a high impedance connection between the charging station and vehicle to ensure that in the event of a voltage mismatch, an inrush current is limited and the life of contactors is extended by reducing the arcing of the contacts;
a charging stations HVDC bus being isolated from an electric vehicle being charged by an additional set of contactors; wherein the DC converters synchronize the bus voltage with the vehicle battery voltage prior to establishing a connection.

7. The switch matrix of claim 6, wherein individual charging stations are also connected to external power sources and/or heatsinks.

8. The switch matrix of claim 6, wherein the connection of internally connected DC busses to individual power converters and the connection of externally connected DC busses to individual charging stations are located adjacent to a power cabinet or to a stationary energy storage with active front end or MPPT from PV installation.

9. The switch matrix of claim 6, wherein monitoring current detects voltage mismatch.

10. The modular scalable fast charging system of claim 1, wherein the dynamic allocation of power to connected electric vehicles is optimized, based on, at least, the following parameters, to ensure minimal charge time for the connected vehicles:
a) the present thermal condition of charging system;
b) the present thermal condition of the battery pack in the vehicle;
c) the thermal model of the battery pack in the vehicle that predicts the actual vehicle battery pack ability to accept charge based on thermal conditions; and
d) the amount of time the vehicle has allocated for the charge session, as well as the desired amount of energy (kWhrs). These parameters can be obtained via the user interface.

11. The modular scalable fast charging system of claim 1, wherein the system is configured and arranged to measure input power utilization of an associated parking structure or associated building in real time, and thus is able to adjust the total available power to the charging infrastructure dynamically, such as to ensure the total available power capacity to the building and charging infrastructure is not exceeded.

12. The modular scalable fast charging system of claim 1, wherein the system is configured and arranged to anticipate input power utilization of an associated parking structure or associated building in real time, by communicating directly with specific high power loads in the associated building, and thus the system is configured and arranged to adjust the total available power to the charging infrastructure dynamically, such as to ensure the total available power capacity to the building and charging infrastructure is not exceeded.

13. The modular scalable fast charging system of claim 12, wherein the specific high power loads are heating systems, cooling systems, escalator systems, or elevator systems.
